(19) United States
(12) Patent Application Publication
(10) Pub. No.: US 2006/0128935 A1
(43) Pub. Date: Jun. 15, 2006

(54) Manufacture of macrocyclic polyester oligomers

(76) Inventors: Wilson Tam, Boothwyn, PA (US); David T. Williamson, Hockessin (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/270,020

(22) Filed: Nov. 9, 2005

Related U.S. Application Data
(60) Provisional application No. 60/626,187, filed on Nov. 9, 2004.

(51) Int. Cl. C08G 63/02

(52) U.S. Cl. 528/272

(57) ABSTRACT

Macrocyclic polyester oligomers can be manufactured in relatively high yields by contacting, a solution of a low oligomer of an organic diester and a diol, with an N-heterocyclic carbene-containing catalyst.

This application claims the benefit of U.S. Provisional Application No. 60/626,187, filed on Nov. 9, 2004, which is incorporated in its entirety as a part hereof for all purposes.

### TECHNICAL FIELD

Macrocyclic polyester oligomers can be manufactured in relatively high yields by contacting a solution of a low oligomer of an organic diester and a diol with an N-heterocyclic carbene-containing catalyst.

### BACKGROUND

Macrocyclic polyester oligomers are known in the art; see, for example, U.S. Pat. No. 2,020,298. They are known to be present in varying, usually small, quantities in many linear polyesters and have been isolated from such linear polyesters. They are often low viscosity liquids, and it has been known that they may be polymerized to higher molecular weight linear polyesters by ring opening polymerization; see, for example, U.S. Pat. Nos. 5,466,744 and 5,661,214 and references cited therein. This ability to readily form a high molecular weight polymer from a relatively low viscosity liquid has made macrocyclic polyester oligomers attractive as materials for manufacturing processes wherein a low viscosity material is converted to a high molecular polymer in a mold, so that a final shaped part is obtained. They are also attractive candidates as coatings and as encapsulants for electrical components and electronic devices.

Synthesis of the macrocyclic polyester oligomers may be achieved by contacting at least one diol with at least one diacid chloride. The reaction typically is conducted in the presence of at least one amine that has substantially no steric hindrance around the basic nitrogen atom. See, e.g., U.S. Pat. No. 5,039,783.

Macrocyclic polyester oligomers also can be prepared via the condensation of a diacid chloride with at least one bis(hydroxyalkyl) ester such as bis(4-hydroxybutyl)terephthalate in the presence of a highly unhindered amine or a mixture thereof with at least one other tertiary amine such as triethylamine. The condensation reaction is conducted in a substantially inert organic solvent such as methylene chloride, chlorobenzene, or a mixture thereof. See, e.g., U.S. Pat. No. 5,231,161.

Both of these methods suffer from the relatively high cost of diacid chlorides and the need for a base to react with the HCl formed in the process. These high manufacturing costs have in many cases prevented the use of macrocyclic ester oligomers commercially, and therefore lower cost routes to macrocyclic polyester oligomers are of great interest.

Another method for preparing macrocyclic polyester oligomers or macrocyclic co-oligoesters is the depolymerization of linear polyester polymers in the presence of an organotin or titanate compound. In this method, linear polyesters are converted to macrocyclic polyester oligomers by heating a mixture of linear polyesters, an organic solvent, and a transesterification catalyst such as a tin or titanium compound. The solvents used, such as o-xylene and o-dichlorobenzene, usually are substantially free of oxygen and water; solvents must be kept scrupulously dry when titanates are used as catalysts. See, e.g., U.S. Pat. Nos. 5,407,984 and 5,668,186; and D. J. Brunelle in Cyclic Polymers, Second Edition, [J. A. Semlyn (ed.), (2000), Kluwer Academic Publishers (Netherlands), pp. 185-228]. The nature of ring-chain equilibrium dictates that the percent yield of cyclic versus linear species drops off significantly as the concentration of starting polymer increases.

More recently, it has been found that polyesters can be made from carboxylic diacids or their diesters and diols using enzymes which catalyze (trans)esterification [see, for example, (i) X. Y. Wu, et al., Journal of Industrial Microbiology and Biotechnology, vol. 20, p. 328-332 (1998); (ii) E. M. Anderson, et al., Biocatalysis and Biotransformation, vol. 16, p. 181-204(1998); and (iii) H. G. Park, et al., Biocatalysis, vol. 11, p. 263-271(1994)]. In some instances in such reactions, the production of small amounts of macrocyclic polyester oligomer coproducts has also been reported [see, for example, G. Mezoul, et al., Polymer Bulletin, vol. 36, p. 541-548(1996)]. There has also been a study reported on the amounts of macrocyclic polyester oligomers, which should be present in such reactions [C. Berkane, et al., Macromolecules, vol. 30, p. 7729-7734(1997)]. This study concluded that formation of the macrocyclic polyester oligomers in the enzyme catalyzed reactions followed the same type of rules that govern the formations of these macrocyclic polyester oligomers in nonenzymatic catalyzed reactions, and that only small fractions of macrocyclic polyester oligomers should be produced in such enzymatic reactions unless very dilute conditions obtained. In all of these references, the byproduct alcohol or water from the transesterification/esterification was removed (usually by sparging with an inert gas) to drive the polymeric product to higher molecular weight.

A recent paper [A. Lavalette, et al., Biomacromolecules, vol. 3, p. 225-228 (2002)] describes a process whereby an enzymatically catalyzed reaction of dimethyl terephthalate and di(ethylene glycol) or bis(2-hydroxyethyl)thioether leads to essentially complete formation of the dimeric cyclic ester, while use of 1,5-pentanediol leads to a relatively high yield of the dimeric cyclic ester, along with some linear polyester. The formation of high yields of the cyclic with di(ethylene glycol) and bis(2-hydroxyethyl)thioether is attributed to a π-stacking-type short range interaction, which favored formation of the dimeric cyclic ester.

The use of enzymes as catalysts is limited, however, as they are unstable above about 70-80° C. and there are limitations as to what solvents may be used.

There thus remains a need for an effective, flexible, and efficient process for preparing macrocyclic polyester oligomers.

### SUMMARY

One embodiment of this invention is a process for the production of a macrocyclic polyester oligomer, comprising contacting in solution:
(1) at least one diester of dicarboxylic acid;
(2) at least one diol; and
(3) at least one compound described by the formula 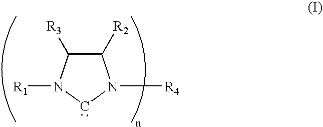
   wherein:
R₁ is an adamantyl, alkaryl, or alkyl group;
R₂ and R₃ are independently hydrogen or a C₁₋₁₂ alkyl group;
n equals 1 or 2; and
R₄ equals R₁ when n equals 1 and is an alkylene group when n equals 2.

Another embodiment of this invention is a process for the production of a macrocyclic polyester oligomer, comprising contacting in solution:
(1) at least one diester of dicarboxylic acid;
(2) at least one diol; and
(3) at least one compound described by the formula 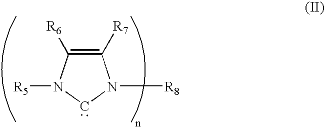
   wherein
R₅ is an adamantyl, alkaryl, or alkyl group;
R₆ and R₇ are each independently hydrogen or a C₁₋₁₂ alkyl group;
n equals 1 or 2; and
R₈ equals R₅ when n equals 1 and is an alkylene group when n equals 2.

A further embodiment of this invention is a process for the production of a macrocyclic polyester oligomer, comprising contacting in solution:
(1) at least one diester of dicarboxylic acid;
(2) at least one diol; and
(3) at least one compound described by the formula: 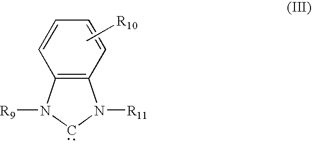
   wherein
R₉ and R₁₁ are each independently an adamantyl, alkaryl, or alkyl group, and
R₁₀ is hydrogen or a C₁₋₁₂ alkyl group.

### DETAILED DESCRIPTION

In the context of this disclosure, a number of terms shall be utilized.

As used herein, the term “N-heterocyclic carbene” denotes a closed ring system containing at least one nitrogen ring atom and a ring atom that is a divalent carbon.

As used herein, the term “adamantyl” means the radical formed by the loss of a hydrogen atom from adamantane (C₁₀H₁₆). The 2-isomer is shown below:

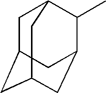

As used herein, the term “mesityl” means the radical formed by the loss of a ring hydrogen from 1,3,5-trimethylbenzene, that is, 2,4,6,-(CH₃)₃C₆H₂—

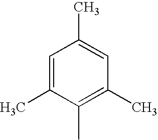

As used herein, a “macrocyclic” molecule means a cyclic molecule having at least one ring within its molecular structure that contains 8 or more atoms covalently connected to form the ring.

As used herein, an “oligomer” means a molecule that contains 2 or more identifiable structural repeat units of the same or different formula.

As used herein, a “macrocyclic polyester oligomer” means a macrocyclic oligomer containing 2 or more identifiable ester functional repeat units of the same or different formula. A macrocyclic polyester oligomer typically refers to multiple molecules of one specific formula having varying ring sizes. However, a macrocyclic polyester oligomer may also include multiple molecules of different formulae having varying numbers of the same or different structural repeat units. A macrocyclic polyester oligomer may be a co-oligoester or multi-oligoester, i.e., a polyester oligomer having two or more different structural repeat units having an ester functionality within one cyclic molecule.

As used herein, the term “alkyl” denotes a univalent group derived from an alkane by removing a hydrogen atom from any carbon atom:
—CₙH₂ₙ₊₁ where n≧1.

As used herein, the term “aryl” denotes a univalent group whose free valence is to a carbon atom of an aromatic ring. The aryl moiety may contain one or more aromatic ring and may be substituted by inert groups, i.e., groups whose presence does not interfere with the operation of the polymerization catalyst system.

As used herein, “alkaryl” denotes an aryl group, which bears at least one alkyl group. Examples are the mesityl group (i.e., 2,4,6-trimethylphenyl) and the 2,6-diisopropylphenyl group (i.e., the (CH₃CHCH₃)₂C₆H₃— radical).

As used herein, “an alkylene group” means —CₙH₂ₙ— where n≧1.

As used herein, “a cycloalkylene group” means a cyclic alkylene group, —CₙH₂ₙ₋ₓ—, where x represents the number of H's replaced by cyclization(s).

As used herein, “a mono- or polyoxyalkylene group” means [—(CH₂)_{y}—O—]ₙ—(CH₂)_{y}—, wherein y is an integer greater than 1 and n is an integer greater than 0.

As used herein, “an alicyclic group” means a non-aromatic hydrocarbon group containing a cyclic structure therein.

As used herein, “a divalent aromatic group” means an aromatic group with links to other parts of the macrocyclic molecule. For example, a divalent aromatic group may include a meta- or para-linked monocyclic aromatic group.

Where a range of numerical values is recited herein, unless otherwise stated, the range is intended to include the endpoints thereof, and all integers and fractions within the range. It is not intended that the scope of the invention be limited to the specific values recited when defining a range.

It has been found that compounds containing N-heterocyclic carbene effectively catalyze the production of macrocyclic polyester oligomers from diester(s) and diol(s). Such catalysts are stable at high temperatures and allow the use of a variety of solvents.

Macrocyclic polyester oligomers that may be produced using the present invention include without limitation macrocyclic poly(alkylene dicarboxylate) oligomers having a structural repeat unit of the formula: 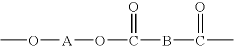
wherein A is an alkylene group containing at least two carbon atoms, a cycloalkylene, or a mono- or polyoxyalkylene group; and B is a divalent aromatic or alicyclic group.

Synthesis of the macrocyclic polyester oligomers may be achieved by contacting at least one diol of the formula HO—A—OH with at least one diester of the formula: 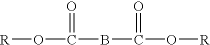
wherein B is defined as above and R is an alkyl group, with at least one N-heterocyclic carbene-containing catalyst.

Preferred diesters are the dimethyl esters of isophthalic acid, substituted isophthalic acids, terephthalic acid, substituted terephthalic acids, and 2,6-naphthalenedicarboxylic acid, and combinations thereof.

Preferred diols are ethylene glycol, di(ethylene glycol), 1,3-propanediol, 1,4-butanediol, 1,6-hexanediol and mixtures thereof, isophthalic acid with 1,3-propanediol, 1,4-butanediol, 1,6-hexanediol, cyclohexanedimethanol, and mixtures thereof.

Preferred macrocyclic polyester oligomers produced by the present invention include macrocyclic oligomers of 1,4-butylene terephthalate (CBT); 1,3-propylene terephthalate (CPT); 1,4-cyclohexylenedimethylene terephthalate (CCT); ethylene terephthalate (CET); 1,2-ethylene 2,6-naphthalenedicarboxylate (CEN); the cyclic ester dimer of terephthalic acid and di(ethylene glycol) (CPEOT); and macrocyclic co-oligoesters comprising two or more of the above structural repeat units.

In one embodiment of the present invention, the N-heterocyclic carbene-containing catalyst is a compound of the formula 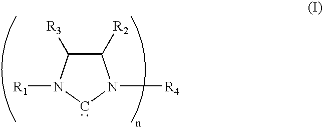
wherein:
R₁ is an adamantyl, alkaryl, or alkyl group;
R₂ and R₃ are independently hydrogen or a C₁₋₁₂ alkyl group;
and n equals 1 or 2. R₄ equals R₁ when n equals 1 and is an alkylene group when n equals 2.

Preferred are compounds in which R₁ is mesityl, R₂ and R₃ are hydrogen, and R₄═R₁. Some illustrative examples are: 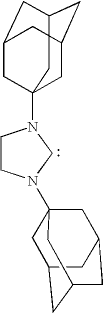
1,3-bis(1-adamantyl)-4,5-dihydroimidazol-2-ylidene 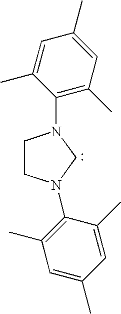
1,3-bis(2,4,6-trimethylphenyl)-4,5-dihydroimidazol-2-ylidene and 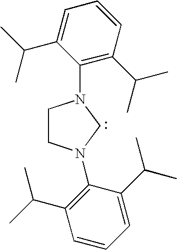
1,3-bis(2,6-diisopropylpheny)-4,5dihydroimidazol-2-ylidene

In a further embodiment of the present invention, the N-heterocyclic carbene-containing catalyst is a compound of the formula 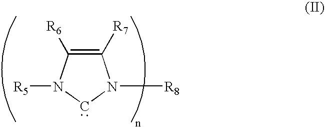
wherein R₅ is an adamantyl, alkaryl, or alkyl group; R₆ and R₇ are each independently hydrogen or a C₁₋₁₂ alkyl group; and n equals 1 or 2. R₈ equals R₅ when n equals 1 and is an alkylene group when n equals 2.

Preferred are compounds in which R5 is mesityl, R₆ and R₇ are hydrogen, and R₈═R₅.

Non-limiting examples of compounds of formula (II) are 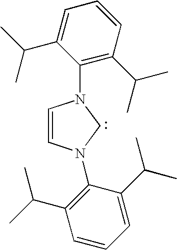
1,3-bis(2,6-diisopropylpheny)imidazol-2-ylidene 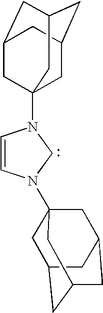
1,3-di-1-adamantyl-imidazole-2-ylidene and 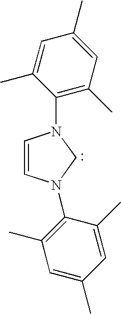
1,3-bis(2,4,6-trimethylphenyl)imidazol-2-ylidene

In yet another embodiment of the present invention, the N-heterocyclic carbene-containing catalyst is a compound of the formula 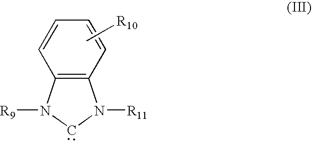
wherein R₉ and R₁₁ are each independently an adamantyl, alkaryl, or alkyl group and R₁₀ is hydrogen or a C₁₋₁₂ alkyl group. Preferred are compounds in which R₉═R₁₁=mesityl and R₁₀ is hydrogen.

Carbenes specified by structure (III) are described in Cetinkaya, E.; Hitchcock, P. B.; Kuecuekbay, H.; Lappert, M. F.; Al-Juaid, S.; J. Organometallic Chemistry (1994), 481, 89-95 and Teles, J. H.; Melder, J.-P.; Ebel, K.; Schneider, R.; Gehrer, E.; Harder, W.; Brode, S.; and Enders, D.; Breuer, K.; Raabe, G.; Helvetica Chimica Acta (1996), 79(1), 61-83.

The process is typically run at 15 to 100° C., preferably at 40 to 80° C. A solvent may be used, and, when used, preferred solvents are those which inert to the reactants and catalyst under reaction conditions. Examples include, but are not limited to, toluene, t-amyl alcohol and other tertiary alcohols, and tetrahydrofuran.

The catalyst concentration in the reaction mixture is not critical and can range from very dilute (e.g., 0.001 M) to relatively high (e.g., 2 M). For economically viable processes, it is recommended that the concentration not be too low.

The process may be run as a batch, semibatch or continuous process. The volatiles may be removed continuously by any of several means known in the art, such as reactive distillation; reaction onto a continuously regenerated absorption bed containing, for example, molecular sieves; or extraction with a suitable solvent. If volatile byproducts are removed using a flow of an inert gas (for example sparging), the volatiles in the gas may be recovered, for example by cooling the gas and condensing the volatiles, and/or the gas may be recycled in the process.

The desired macrocyclic polyester oligomer(s) may be recovered by normal techniques. For example, if the macrocyclic polyester oligomer is a solid, it may be recovered from solution by cooling the solution and/or removing some or all of the solvent, and then recovering the solid macrocyclic polyester oligomer by filtration. If there is some linear polyester (of any molecular weight) remaining in the process, it may be possible to separate the macrocyclic polyester oligomer (s) from the linear polyester by differential precipitation from one or more solvents.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows: “DMT” means Dimethyl terephthalate, “DEG” means di(ethylene glycol), “min” means minute(s), “g” means gram(s), “mg” means milligram(s), “Al” means microliter(s), “mmol” means millimole(s), “GC” means gas chromatography, and “LC” means liquid chromatography.

Experimental

Materials

The N-heterocyclic carbenes were prepared as described in M. Niehues, G. Kehr, G. Erker, B. Wibbeling, R. Frohlich, O. Blacque, H. Berke, J. Organometallic Chem., 2002, Vol. 663, pp. 192-203; W. A. Herrmann, C. Kocher, L. J. Goozen, and G. R. J. Artus, Chem. Eur. J. 1996, p. 1627; and A. J. Arduengo, III, R. Krafczyk, R. Schmutzler, H. A. Craig, J. R. Goerlich, W. J. Marshall, M. Unverzagt, Tetrahedron, 1999, Vol. 55, pp. 14523-14534.

Dimethyl terephthalate (CAS # 120-61-6), di(ethylene glycol) (CAS # 111-46-6), and 1,4-butanediol (CAS # 110-63-4) were obtained from Aldrich Chemical Company (Milwaukee, Wis.) and were used as received.

T-amyl alcohol was obtained from Sigma-Aldrich Corporation (St. Louis, Mo., 99%, catalog number 152463). Toluene was obtained from EMD Chemicals, Inc. (Gibbstown, N.J., DriSolv® toluene, anhydrous, 99.8% minimum, catalog number TX0732-6). Both solvents were degassed with nitrogen and stored over 4A molecular sieves. The 4A molecular sieve pellets were first heated at 500° C. for five hours.

Product Analysis

Reaction product samples were analyzed by LC using the following technique. The reaction solvent used in the reaction mixture was stripped off under vacuum at a temperature of 30 to 50° C. Chloroform was added to about 1 to 3 times the original reaction volume before stripping. In some cases, the reaction solvent was not stripped off and the volume of chloroform added directly to the reaction mixture. The amount of chloroform added depended on the original concentrations of reactants used. The enzyme support floated to the top of chloroform while oligomers and unreacted diol and diester readily dissolved. An aliquot was removed from the clear solution and filtered. An equal volume of a suitable standard in chloroform was added to this filtered aliquot and loaded into an LC vial.

Analysis was carried out using a Waters® Alliance® Separations (Waters Corporation, Milford, Mass.) HPLC 1100 module 2695 Liquid Chromatograph equipped with a UV diode array detector. A 250 mm by 4.6 mm, 5 micron particle size, Spherisorb® silica column (Cat. #Z226025, Supelco, Inc., Bellefonte, Pa.) was utilized. A mixed mobile phase with a solvent gradient was used at a total elution rate of 0.5 ml/min. Initially a 50/50 mix of octane and chloroform was used for the mobile phase. This mix was changed linearly to 100% chloroform at 10 minutes and back to the 50/50 mixture at 25 minutes. Macrocyclic polyester oligomer peaks were identified by retention time. Samples of pure macrocyclic polyester oligomer extracted from the corresponding high molecular weight polymer or isolated from previous reactions were used to confirm the retention times of the macrocyclic polyester oligomer peaks. Concentrations of macrocyclic polyester oligomers were determined using the internal standard and a response factor of the pure isolated oligomers relative to the standard. For some CPEOT samples, the mobile phase was a fixed mixture of 35/65 octane/chloroform, and a different standard was added to the sample.

### Example 1

A stock solution containing 0.194 g of dimethyl terephthalate, 0.106 g of di(ethylene glycol) and 4.700 g toluene was prepared. To each vial was added 170-200 mg of 4A molecular sieves and 530 μl (about 470 mg) of stock solution. To vial A was added 11 mg of 1,3-bis(2,4,6-trimethylphenyl)imidazol-2-ylidene. To vial B was added 14 mg of 1,3-bis(2,4,6-trimethylphenyl)imidazol-2-ylidene. Vial A was stirred at room temperature for 2 days and vial B was heated at 60° C. for 2 days. LC analysis for the sample in vial A indicated 82% yield of CPEOT. The LC analysis for the sample in vial B indicated 89% yield of CPEOT. LC/MS indicated only CPEOT.

### Example 2

A mixture was prepared from 0.777 g of dimethyl terephthalate, 0.424 g of di(ethylene glycol), 8.799 g of toluene and 0.061 g of 1,3-bis(2,4,6-trimethylphenyl)imidazol-2-ylidene. The level of the solution was noted and marked. The mixture was heated at 60° C. under a slight vacuum. After 2 hours, toluene was added to adjust the solution level to the original mark. After a total reaction time of 3.5 hours, the solid was removed by filtration. To the filtrate were added 0.777 g of dimethyl terephthalate and 0.424 g of di(ethylene glycol) and enough toluene to filled back to the original mark. The mixture was heated again at 60° C. under slight vacuum for 3 hours. The solid was filtered. The filtrate was concentrated and allowed to stand overnight. More precipitate formed which was collected. A total of 1.335 g of white solid was collected. LC indicated the sample to be CPEOT with a purity of around 80%. The filtrate was treated with more di(ethylene glycol) (0.848 g) and dimethyl terephthalate (1.554 g) to give 1.337 of CPEOT with 90% purity as determined by LC.

### Example 3

In a vial was added 0.180 g of 1,4-butanediol, 9.432 g of t-amyl alcohol and 0.388 g of dimethyl terephthalate. The vial was heated at 60° C. and 0.030 g of 1,3-bis(2,4,6-trimethylphenyl)imidazol-2-ylidene was added. Vacuum was applied to remove any formed methanol. The sample was kept at 60° C. for 4 hours. The vial was then sealed with a septum and a needle pierced through the septum to allow volatile to be removed. The vial was heated overnight at 75 C. LC analysis indicated 10% yield of CBT.

### Example 4

In a vial was added 0.090 g of 1,4-butanediol, 9.716 g of t-amyl alcohol and 0.194 g of dimethyl terephthalate. This solution was warmed at 50° C. in a hot block. In another vial was added 250-260 mg of 4A molecular sieves, 2.012 g of the above solution and 30 mg of 1,3-bis(adamantyl)imidazol-2-ylidene. The mixture was stirred for a week at room temperature. LC analysis indicated 12% CBT.

### Example 5

In a vial was added 0.090 g of 1,4-butanediol, 9.716 g of t-amyl alcohol and 0.194 g of dimethyl terephthalate. This solution was warmed at 50° C. in a hot block. In another vial was added 250-260 mg of 4A molecular sieves, 2.019 g of the above solution and 33 mg of 1,3-bis(2,6-diisopropylphenyl)imidazol-2-ylidene. The mixture was stirred for a week at room temperature. LC analysis indicated 7% CBT.

### Example 6

In a vial was added 0.106 g of di(ethylene glycol), 4.700 g of toluene and 194 g of dimethyl terephthalate. In another vial was added 250-260 mg of 4A molecular sieves, 1.018 g of the above solution and 29 mg of 1,3-bis(adamantyl)imidazol-2-ylidene. The mixture was stirred for a week at room temperature. LC analysis indicated 7% CPEOT.

### Example 7

In a vial was added 0.106 g of di(ethylene glycol), 4.700 g toluene and 0.194 g of dimethyl terephthalate. In another vial was added 250-260 mg of 4A molecular sieves, 1.022 g of the above solution and 35 mg of 1,3-bis(2,6-diisopropylphenyl)imidazol-2-ylidene. The mixture was stirred for a week at room temperature. LC analysis indicated 26% CPEOT.

What is claimed is:

1. A process for the production of a macrocyclic polyester oligomer, comprising contacting in solution:
(a) at least one diester of a dicarboxylic acid;
(b) at least one diol; and
(c) at least one compound described by the formula 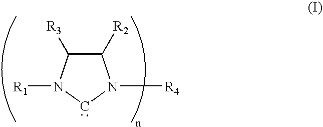
wherein:
R₁ is an adamantyl, alkaryl, or alkyl group;
R₂ and R₃ are each independently hydrogen or a C₁₋₁₂ alkyl group;
n equals 1 or 2; and
R₄ equals R₁ when n equals 1 and is an alkylene group when n equals 2.

2. A process according to claim 1 wherein R₁ is mesityl.

3. A process according to claim 1 wherein R₂ and R₃ are hydrogen.

4. A process according to claim 1 wherein R₄═R₁.

5. A process according to claim 1 wherein the catalyst is 1,3-bis(1-adamantyl)-4,5-dihydroimidazol-2-ylidene.

6. A process according to claim 1 wherein the catalyst is 1,3-bis(2,4,6-trimethylphenyl)-4,5-dihydroimidazol-2-ylidene.

7. A process according to claim 1 wherein the catalyst is 1,3-bis(2,6-diisopropylpheny)-4,5dihydroimidazol-2-ylidene.

8. A process according to claim 1 wherein the diester is selected from one or more members of the group consisting of the dimethyl esters of isophthalic acid, substituted isophthalic acids, terephthalic acid, substituted terephthalic acids, and 2,6-naphthalenedicarboxylic acid.

9. A process according to claim 1 wherein the diol is selected from one or more members of the group consisting of ethylene glycol, di(ethylene glycol), 1,3-propanediol, 1,4-butanediol, 1,6-hexanediol, isophthalic acid with 1,3-propanediol, 1,4-butanediol, 1,6-hexanediol, cyclohexanedimethanol.

10. A process for the production of a macrocyclic polyester oligomer, comprising contacting in solution:
(a) at least one diester of a dicarboxylic acid;
(b) at least one diol; and
(c) at least one compound described by the formula 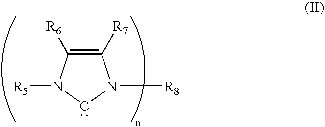
wherein
R₅ is an adamantyl, alkaryl, or alkyl group;
R₆ and R₇ are each independently hydrogen or a C₁₋₁₂ alkyl group;
n equals 1 or 2; and
R₈ equals R₅ when n equals 1 and is an alkylene group when n equals 2.

11. A process according to claim 10 wherein R₅ is mesityl.

12. A process according to claim 10 wherein R₆ and R₇ are hydrogen.

13. A process according to claim 10 wherein R₈═R₅.

14. A process according to claim 10 wherein the catalyst is 1,3-bis(2,6-diisopropylpheny)imidazol-2-ylidene.

15. A process according to claim 10 wherein the catalyst is 1,3-di-1-adamantyl-imidazole-2-ylidene.

16. A process according to claim 10 wherein the catalyst is 1,3-bis(2,4,6-trimethylphenyl)imidazol-2-ylidene.

17. A process according to claim 10 wherein the diester is selected from one or more members of the group consisting of the dimethyl esters of isophthalic acid, substituted isophthalic acids, terephthalic acid, substituted terephthalic acids, and 2,6-naphthalenedicarboxylic acid.

18. A process according to claim 10 wherein the diol is selected from one or more members of the group consisting of ethylene glycol, di(ethylene glycol), 1,3-propanediol, 1,4-butanediol, 1,6-hexanediol, isophthalic acid with 1,3-propanediol, 1,4-butanediol, 1,6-hexanediol, cyclohexanedimethanol.

19. A process for the production of a macrocyclic polyester oligomer, comprising contacting in solution:
(a) at least one diester of a dicarboxylic acid;
(b) at least one diol; and
(c) at least one compound described by the formula 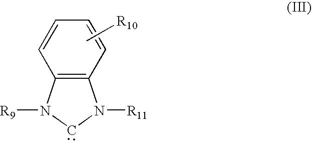
wherein:
R₉ and R₁₁ are each independently an adamantyl, alkaryl, or alkyl group; and
R₁₀ is hydrogen or a C₁₋₁₂ alkyl group.

20. A process according to claim 19 wherein R₉ is mesityl.

21. A process according to claim 19 wherein R₁₁ is mesityl.

22. A process according to claim 19 wherein R₁₀ is hydrogen.

23. A process according to claim 19 wherein the diester is selected from one or more members of the group consisting of the dimethyl esters of isophthalic acid, substituted isophthalic acids, terephthalic acid, substituted terephthalic acids, and 2,6-naphthalenedicarboxylic acid.

24. A process according to claim 19 wherein the diol is selected from one or more members of the group consisting of ethylene glycol, di(ethylene glycol), 1,3-propanediol, 1,4-butanediol, 1,6-hexanediol, isophthalic acid with 1,3-propanediol, 1,4-butanediol, 1,6-hexanediol, cyclohexanedimethanol.
